(19) United States
(12) Patent Application Publication
(10) Pub. No.: US 2024/0377769 A1
(43) Pub. Date: Nov. 14, 2024

(54) TONER

(71) Applicant: KYOCERA Document Solutions Inc., Osaka (JP)

(72) Inventor: Masaki OKITA, Osaka-shi (JP)

(73) Assignee: KYOCERA Document Solutions Inc., Osaka (JP)

(21) Appl. No.: 18/659,754

(22) Filed: May 9, 2024

(30) Foreign Application Priority Data
May 10, 2023 (JP) 2023-078077

(51) Int. Cl. G03G 9/087; C08G 63/195; G03G 9/08

(52) U.S. Cl. CPC G03G 9/08755; C08G 63/195; G03G 9/0819; G03G 9/08797

(57) ABSTRACT

A toner includes toner particles each including a pulverized toner mother particle and an external additive attached to the surface of the toner mother particle. The toner mother particles have a volume median diameter of at least 5.20 m and no greater than 6.50 μm and contain a binder resin containing a tetrahydrofuran-insoluble component in a percentage content of at least 4.50% by mass and no greater than 16.00% by mass. The tetrahydrofuran-insoluble component has a percentage content of no greater than 2.20% by mass in the binder resin as subjected to ultrasonication at an output power of 200 W and a frequency of 28 kHz for 1 minute. In an infrared absorption spectrum of the toner particles plotted by infrared spectroscopy, a peak appearing at a wavenumber of 701 cm⁻¹ has a height of at least 0.0070 A and no greater than 0.0300 A.

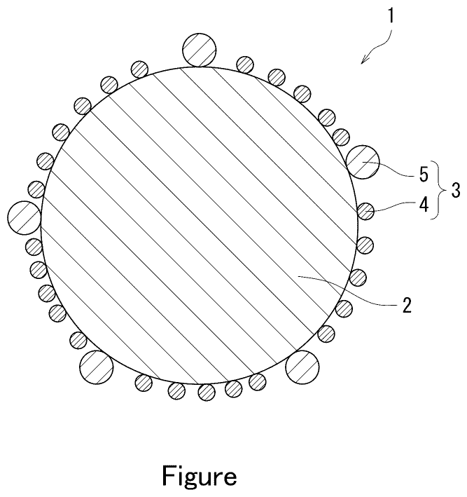

### INCORPORATION BY REFERENCE

The present application claims priority under 35 U.S.C. § 119 to Japanese Patent Application No. 2023-078077, filed on May 10, 2023. The contents of this application are incorporated herein by reference in their entirety.

### BACKGROUND

The present disclosure relates to a toner.

Toners including positively chargeable toner particles are used in electrographic image forming apparatuses, for example. The toners are required to have excellent low-temperature fixability and heat-resistant preservability and to be able to form images with excellent coloring. To meet such requirements, a toner for development use is proposed that includes toner particles with a certain amount of tetrahydrofuran (THF)-insoluble components in a specific range.

### SUMMARY

A toner according to an aspect of the present disclosure includes toner particles. The toner particles each include a toner mother particle and an external additive attached to a surface of the toner mother particle. The toner mother particles are pulverized toner mother particles. The toner mother particles have a volume median diameter of at least 5.20 μm and no greater than 6.50 μm. The toner mother particles contain a binder resin. The binder resin contains a tetrahydrofuran-insoluble component in a percentage content of at least 4.50% by mass and no greater than 16.00% by mass. The tetrahydrofuran-insoluble component has a percentage content of no greater than 2.20% by mass in the binder resin as subjected to ultrasonication at an output power of 200 W and a frequency of 28 kHz for 1 minute. In an infrared absorption spectrum of the toner particles plotted by infrared spectroscopy, a peak appearing at a wavenumber of 701 cm⁻¹ has a height of at least 0.0070 A and no greater than 0.0300 A.

### BRIEF DESCRIPTION OF THE DRAWINGS

FIGURE is a diagram illustrating an example of a toner particle.

### DETAILED DESCRIPTION

The following describes preferred embodiments of the present disclosure. Note that a toner is a collection (e.g., a powder) of toner particles. An external additive is a collection (e.g., a powder) of external additive particles. Unless otherwise stated, evaluation results (e.g., values indicating shape or physical properties) for a powder (specific examples include a powder of toner particles, a powder of external additive particles, and a magnetic powder) are number averages of values as measured for a suitable number of particles selected from the powder.

Measurement values for volume median diameter (D₅₀) of a powder are values as measured using a laser diffraction/scattering type particle size distribution analyzer (e.g., “LA-920V2” produced by HORIBA, Ltd. or “COULTER COUNTER MULTISIZER 3” produced by Beckman Coulter, Inc.) unless otherwise stated.

The number average particle diameter of a powder is a number average value of equivalent circle diameters of primary particles (Heywood diameters: diameters of circles having the same areas as projected areas of the primary particles) of the powder as measured using a scanning electron microscope. The number average primary particle diameter of a powder is a number average value of equivalent circle diameters of 100 primary particles of the powder, for example. The number average primary particle diameter of particles refers to a number average primary particle diameter of the particles of a powder unless otherwise stated.

Chargeability means chargeability in triboelectric charging unless otherwise stated. For example, a measurement target (e.g., a toner) is triboelectrically charged by mixing and stirring the measurement target with a standard carrier (standard carrier for use with negatively chargeable toner: N-01, standard carrier for use with positively chargeable toner: P-01) provided by The Imaging Society of Japan. The amount of charge of the measurement target is measured using for example a suction-type compact electrostatic charge measuring device (“MODEL 212HS”, product of TREK, INC.) before and after triboelectric charging. A larger change in amount of charge between before and after triboelectric charging indicates stronger chargeability of the measurement target.

The softening point (Tm) is a value as measured using a capillary rheometer (“CFT-500D”, product of Shimadzu Corporation) unless otherwise stated. On an S-shaped curve (vertical axis: temperature, horizontal axis: stroke) as plotted using the capillary rheometer, the softening point (Tm) corresponds to the temperature corresponding to a stroke value of “(base line stroke value+maximum stroke value)/2”.

Values for melting point (Mp) each are a temperature at a maximum endothermic peak in an endothermic curve (vertical axis: heat flow (DSC signal), horizontal axis: temperature) as plotted using a differential scanning calorimeter (“DSC-6220”, product of Seiko Instruments Inc.) unless otherwise state. The endothermic peak appears due to melting of the crystallization site.

The glass transition point (Tg) is a value as measured in accordance with “the Japanese Industrial Standards (JIS) K7121-2012” using a differential scanning calorimeter (“DSC-6220”, product of Seiko Instruments Inc.) unless otherwise stated. The glass transition point (Tg) corresponds to the temperature corresponding to a point of inflection (specifically, an intersection point of an extrapolated baseline and an extrapolated falling line) caused by glass transition in a heat absorption curve (vertical axis: heat flow (DSC signal), horizontal axis: temperature) plotted using the differential scanning calorimeter.

The acid values and the hydroxyl values are values as measured in accordance with “the Japanese Industrial Standards (JIS) K0070-1992” unless otherwise stated.

The “main component” of a material means a component most abundant in the material in terms of mass unless otherwise stated.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

### <Toner>

The following describes a toner according to preferred embodiments of the present disclosure. The toner of the present disclosure includes toner particles. The toner particles each include a toner mother particle and an external additive attached to the surface of the toner mother particle. The toner mother particles are pulverized toner mother particles. The toner mother particles have a volume median diameter of at least 5.20 μm and no greater than 6.50 μm. The toner mother particles contain a binder resin. The binder resin contains a tetrahydrofuran-insoluble component in a percentage content of at least 4.50% by mass and no greater than 16.00% by mass. The tetrahydrofuran-insoluble component has a percentage content of no greater than 2.20% by mass in the binder resin as subjected to ultrasonication at an output power of 200 W and a frequency of 28 kHz for 1 minute. In an infrared absorption spectrum of the toner particles plotted by infrared spectroscopy, a peak appearing at a wavenumber of 701 cm⁻¹ has a height of at least 0.0070 A and no greater than 0.0300 A.

The toner of the present disclosure is favorably used for electrostatic latent image development. The toner of the present disclosure may be used as a one-component developer. The toner of the present disclosure may be mixed with a carrier using a mixer (e.g., a ball mixer) for use as a two-component developer. The toner of the present disclosure, when used as a one-component developer, is charged (e.g., positively charged) by friction with a development sleeve or a toner charging member in a development device. The toner charging member is a doctor blade, for example. The toner of the present disclosure, when constituting a two-component developer, is charged (e.g., positively charged) by friction with a carrier in a development device.

### [Toner Particles]

FIGURE illustrates an example of a toner particle 1 included in the toner of the present disclosure. The toner particle 1 illustrated in FIGURE includes a toner mother particle 2 and an external additive 3 attached to the surface of the toner mother particle 2. The external additive 3 includes silica particles 4 and additional external additive particles 5 other than the silica particles 4.

The toner particle 1 being an example of the toner particles has been described so far with reference to FIGURE as an example. However, the toner particles included in the toner of the present disclosure may have a structure different from that of the toner particle 1 illustrated in FIGURE. Specifically, the external additive in the toner of the present disclosure may include only the silica particles 4 or only the additional external additive particles 5. Alternatively or additionally, the toner particles may be toner particles (also referred to below as capsule toner particles) with shell layers. The toner mother particles in the capsule toner particles each include a toner core containing a binder resin and a shell layer covering the surface of the toner core, for example.

As a result of having the above features, the toner of the present disclosure can have excellent low-temperature fixability and heat-resistant preservability, and can form images with excellent coloring. The reasons why the toner of the present disclosure can exhibit the above advantages are inferred as follows. The toner of the present disclosure contains a certain amount of a tetrahydrofuran-insoluble component in the binder resin. The tetrahydrofuran-insoluble component is a resin with an extremely high molecular weight and an intramolecularly entangled structure. The tetrahydrofuran-insoluble component imparts adequate elasticity to the toner particles to suppress agglomeration of the toner particles. As a result, the tetrahydrofuran-insoluble component imparts heat-resistant preservability to the toner of the present disclosure.

Known toners including highly elastic toner particles by contrast tend to have insufficient low-temperature fixability due to insufficient melting of the toner particles during fixing. The melted toner particles of known toners such as above cannot sufficiently cover (conceal) the surfaces of recording mediums in fixing, tending to form images with insufficient coloring. By contrast, at least a portion of the tetrahydrofuran-insoluble component contained in the toner of the present disclosure is rendered tetrahydrofuran soluble and less elastic upon receipt of external energy (e.g., heat or ultrasonication). Such solubilization and elasticity reduction are due to the relatively simple intramolecular entanglement of the tetrahydrofuran-insoluble component. In other words, resins that are intramolecularly and intricately entangled undergo minimal structural changes even with ultrasonication, and their elasticity and solubility in tetrahydrofuran remain unchanged. By contrast, resins that are relatively simply entangled intramolecularly are untangled to become soluble in tetrahydrofuran and reduce their elasticity when external energy is applied. As such, in the toner of the present disclosure, the percentage content of the tetrahydrofuran-insoluble component is at least 4.50% by mass in the binder resin in the normal state (yet to be subjected to the ultrasonication) and will reduce to no greater than 2.20% by mass after the ultrasonication. In actual image formation, solubilization and elasticity reduction of the tetrahydrofuran-insoluble component occur in a process (heating treatment) for toner particle fixing. As such, the toner particles of the toner of the present disclosure have high elasticity in the normal state (during storage) due to presence of a large amount of tetrahydrofuran-insoluble component. However, the elasticity of the toner particles reduces in fixing as a result of reduction of the tetrahydrofuran-insoluble component. As a result, the toner of the present disclosure can have high heat-resistant preservability and low-temperature fixability and can form images with excellent coloring.

The toner of the present disclosure, in which the volume median diameter of the toner mother particles is optimized, can sufficiently conceal the surfaces of recording mediums with the toner particles and can form images with excellent coloring. In addition, a peak appearing at a wavenumber of 701 cm⁻¹ in an infrared absorption spectrum of the toner particles plotted by infrared spectroscopy has a height of at least 0.0070 A and no greater than 0.0300 A. As a result of the above peak of the toner of the present disclosure having a height in the adequate range (at least 0.0070 A and no greater than 0.0300 A), adequate chargeability can be imparted to the toner particles while a decrease in heat-resistant preservability can be suppressed. Thus, the toner of the present disclosure can have excellent low-temperature fixability and heat-resistant preservability and can form images with excellent coloring.

The toner of the present disclosure is described further in detail below. Unless otherwise stated, one type of each component described below may be used independently, or two or more types of the component may be used in combination.

### [Toner Particles]

The toner particles each include a toner mother particle and an external additive attached to the surface of the toner mother particle. In an infrared absorption spectrum of the toner particles plotted by infrared spectroscopy, a peak appearing at a wavenumber of 701 cm⁻¹ has a height of at least 0.0070 A and no greater than 0.0300 A, preferably at least 0.0110 A and no greater than 0.0200 A, and more preferably at least 0.0150 A and no greater than 0.0200 A. As a result of the peak height being at least 0.0070 A, the toner of the present disclosure is rendered favorably developable, achieving formation of images with excellent coloring. As a result of the peak height being no greater than 0.0300 A, heat-resistant preservability of the toner of the present disclosure can be optimized. Note that the infrared spectroscopy can be performed at a temperature of 25° C. by the method described in Examples or a method in accordance therewith.

Here, the height of the peak appearing at a wavenumber of 701 cm⁻¹ indicates the amount of an aromatic ring structure (especially, a structure derived from styrene). The aromatic ring structure tends to impart adequate chargeability to toner particles. However, toner particles in an excessive amount of the aromatic ring structure tend to have reduced heat-resistant preservability.

The mass average molecular weight of a resin contained in the toner particles is preferably at least 85,000 and no greater than 130,000, more preferably at least 95,000 and no greater than 115,000, and further preferably at least 100,000 and no greater than 111,000. As a result of the mass average molecular weight of the resin contained in the toner particles being set to at least 85,000, heat-resistant preservability of the toner of the present disclosure can be further optimized. As a result of the mass average molecular weight of the resin contained in the toner particles being set to no greater than 130,000, low-temperature fixability of the toner of the present disclosure can be further optimized. The resin contained in the toner particles is typically the same as the binder resin contained in the toner mother particles. The mass average molecular weight of the resin contained in the toner particles can be measured by the method described in Examples or a method in accordance therewith.

### (Toner Mother Particles)

The toner mother particles contain a binder resin as a main component, for example. The toner mother particles may further contain an internal additive (e.g., at least one of a colorant, a releasing agent, a charge control agent, and a magnetic powder) as necessary. The toner mother particles are pulverized toner mother particles obtained by pulverization. The pulverization can facilitate preparation of toner mother particles containing a certain amount of a tetrahydrofuran-insoluble component.

The toner mother particles have a volume median diameter (D₅₀) of at least 5.20 μm and no greater than 6.50 μm, preferably at least 5.50 μm and no greater than 6.20 μm, and further preferably at least 5.70 μm and no greater than 6.00 μm. As a result of the volume median diameter of the toner mother particles being set to at least 5.20 μm, heat-resistant preservability of the toner of the present disclosure can be optimized. As a result of the volume median diameter of the toner mother particles being set to at least 5.20 μm and no greater than 6.50 μm, the toner particles of the toner of the present disclosure can melt to sufficiently cover (conceal) the surfaces of recording mediums in fixing. As a result, the toner of the present disclosure can form images with excellent coloring.

### (Binder Resin)

In terms of providing a toner excellent in low-temperature fixability, the toner mother particles preferably contain a thermoplastic resin as the binder resin, and more preferably contain a thermoplastic resin at a percentage content of at least 85% by mass in the total of the binder resin. Examples of the thermoplastic resin include styrene resins, (meth)acrylic acid ester resins, olefin resins (e.g., polyethylene resin and polypropylene resin), vinyl resins (e.g., vinyl chloride resin, polyvinyl alcohol, vinyl ether resin, and N-vinyl resin), polyester resins, polyamide resins, and urethane resins. Alternatively, a copolymer of any of these resins, that is, a copolymer (e.g., styrene-(meth)acrylic acid ester resin or styrene-butadiene-based resin) in which any repeating unit has been introduced into any of the resins can be used as the binder resin.

The binder resin has a percentage content of preferably at least 60% by mass and no greater than 97% by mass in the toner mother particles, and more preferably at least 85% by mass and no greater than 92% by mass.

The tetrahydrofuran-insoluble component has a percentage content of at least 4.50% by mass and no greater than 16.00% by mass in the binder resin, preferably at least 7.00% by mass and no greater than 15.00% by mass, and more preferably at least 8.00% by mass and no greater than 10.00% by mass. As a result of the percentage content of the tetrahydrofuran-insoluble component being set to at least 4.50% by mass in the binder resin, heat-resistant preservability of the toner of the present disclosure can be optimized. As a result of the percentage content of the tetrahydrofuran-insoluble component being set to no greater than 16.00% by mass in the binder resin, low-temperature fixability of the toner of the present disclosure and coloring of images formed with the toner can be optimized.

The percentage content of the tetrahydrofuran-insoluble component is no greater than 2.20% by mass in the binder resin as subjected to ultrasonication at an output power of 200 W and a frequency of 28 kHz for 1 minute, preferably at least 0.20% by mass and no greater than 2.20% by mass, more preferably at least 0.40% by mass and no greater than 2.00% by mass, and further preferably at least 0.80% by mass and no greater than 1.50% by mass. As a result of the percentage content of the tetrahydrofuran-insoluble component being set to no greater than 2.20% by mass in the binder resin as subjected to the ultrasonication, low-temperature fixability of the toner of the present disclosure and coloring of images formed with the toner can be optimized. As a result of the percentage content of the tetrahydrofuran-insoluble component in the binder resin as subjected to the ultrasonication being set to at least 0.20% by mass, the percentage content of the tetrahydrofuran-insoluble component in the binder resin can be easily adjusted within the aforementioned range.

In terms of further optimizing low-temperature fixability of the toner of the present disclosure, the binder resin is preferably a polyester resin. The polyester resins can be obtained by condensation polymerization of at least one polyhydric alcohol and at least one polybasic carboxylic acid. Examples of the polyhydric alcohol used for synthesis of the polyester resin include dihydric alcohols (e.g., diol compounds and bisphenol compounds) and tri- or higher-hydric alcohols. Examples of the polybasic carboxylic acid for synthesis of the polyester resin include dibasic carboxylic acids and tri- or higher-basic carboxylic acids. Alternatively, a polybasic carboxylic acid derivative (e.g., an anhydride of a polybasic carboxylic acid or a halide of a polybasic carboxylic acid) that can form an ester bond by condensation polymerization may be used instead of the polybasic carboxylic acid.

Examples of the diol compounds include ethylene glycol, diethylene glycol, triethylene glycol, 1,2-propanediol, 1,3-propanediol, 1,4-butanediol, neopentyl glycol, 2-butene-1,4-diol, 1,5-pentanediol, 2-pentene-1,5-diol, 1,6-hexanediol, 1,4-cyclohexanedimethanol, dipropylene glycol, 1,4-benzenediol, polyethylene glycol, polypropylene glycol, and polytetramethylene glycol.

Examples of the bisphenol compounds include bisphenol A, hydrogenated bisphenol A, bisphenol A-ethylene oxide adducts (e.g., polyoxyethylene(2,2)-2,2-bis(4-hydroxyphenyl)propane), and bisphenol A-propylene oxide adducts.

Examples of the tri- or higher-hydric alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the dibasic carboxylic acids include maleic acid, fumaric acid, citraconic acid, itaconic acid, glutaconic acid, phthalic acid, isophthalic acid, terephthalic acid, cyclohexanedicarboxylic acid, adipic acid, sebacic acid. azelaic acid, malonic acid, succinic acid, alkyl succinic acids (specific examples include n-butylsuccinic acid, isobuylsuccinic acid, n-octylsuccinic acid, n-dodecylsuccinic acid, and isododecylsuccinic acid), and alkenyl succinic acids (specific examples include n-butenylsuccinic acid, isobutenylsuccinic acid, n-octenylsuccinic acid, n-dodecenylsuccinic acid, and isododecenylsuccinic acid).

Examples of the tri- or higher-basic carboxylic acids include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxyl propane, 1,2,4-cyclohexanetricarboxylic acid, tetra(methylenecarboxyl)methane, 1,2,7,8-octanetetracarboxylic acid, pyromellitic acid, and empole trimer acid.

The polyester resin may further include a repeating unit derived from a vinyl compound. Examples of the vinyl compound include olefin compounds (e.g., ethylene, propylene, and butylene), styrene compounds, (meth)acrylic acids, and (meth)acrylic acid alkyl esters. The vinyl compound is preferably a styrene compound or a (meth)acrylic acid alkyl ester.

Examples of the styrene compound include styrene, o-methylstyrene, m-methylstyrene, p-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

Examples of the (meth)acrylic acid alkyl ester include methyl (meth)acrylate, ethyl (meth)acrylate, n-propyl (meth)acrylate, iso-propyl (meth)acrylate, n-butyl (meth)acrylate, isobutyl (meth)acrylate, tert-butyl (meth)acrylate, n-octyl (meth)acrylate, 2-ethylhexyl (meth)acrylate, stearyl (meth)acrylate, and lauryl (meth)acrylate.

The binder resin is preferably a non-crystalline polyester resin. However, when the binder resin includes a small amount of a crystalline polyester resin, sharp meltabilty of the toner particles can be optimized. From the above, the binder resin preferably includes both a crystalline polyester resin and a non-crystalline polyester resin. The total percentage content of the crystalline polyester resin and the non-crystalline polyester resin is preferably at least 90% by mass in the binder resin, more preferably at least 99% by mass, and further preferably 100% by mass.

For non-polyester resins, it is often not possible to measure a clear melting point (Mp). Therefore, polyester resins for which no clear endothermic peak can be identified in an endothermic curve plotted using a differential scanning calorimeter may be considered non-crystalline polyester resins.

### (Non-Crystalline Polyester Resin)

When the binder resin includes a non-crystalline polyester resin, the non-crystalline polyester resin preferably includes a first repeating unit derived from a tri- or higher-basic carboxylic acid. The first repeating unit introduces a crosslinking structure into the non-crystalline polyester resin. As a result, the non-crystalline polyester resin increases in molecular weight and becomes moderately and intramolecularly entangled. The non-crystalline polyester resin including an adequate amount of the first repeating unit is insoluble in tetrahydrofuran (i.e., highly elastic) in the normal state and becomes soluble (i.e., less elastic) in tetrahydrofuran upon receipt of external energy (e.g., heat or ultrasonication). The tri- or higher-basic carboxylic acid is preferably trimellitic acid, and more preferably trimellitic anhydride.

The percentage content of the first repeating unit is preferably at least 1.5% by mass and no greater than 7.5% by mass in all repeating units included in the non-crystalline polyester resin, and more preferably at least 3.0% by mass and no greater than 4.5% by mass. As a result of the percentage content of the first repeating unit being set to at least 1.5% by mass and no greater than 7.5% by mass in all the repeating units of the non-crystalline polyester resin, solubility (i.e., elasticity) of the non-crystalline polyester resin in tetrahydrofuran can be easily adjusted.

Preferably, the non-crystalline polyester resin further includes a second repeating unit derived from a bisphenol compound and a third repeating unit derived from a dibasic carboxylic acid. The bisphenol compound is preferably a bisphenol A-ethylene oxide adduct or a bisphenol A-propylene oxide adduct. The dibasic carboxylic acid is preferably n-dodecenylsuccinic anhydride or terephthalic acid.

The percentage content of the second repeating unit is preferably at least 60.0% by mass and no greater than 90.0% by mass in all the repeating units included in the non-crystalline polyester resin, and more preferably at least 70.0% by mass and no greater than 80.0% by mass.

The percentage content of the third repeating unit is preferably at least 10.0% by mass and no greater than 35.0% by mass in all the repeating units included in the non-crystalline polyester resin, and more preferably at least 15.0% by mass and no greater than 25.0% by mass.

The non-crystalline polyester resin has a percentage content of preferably at least 50.0% by mass and no greater than 95.0% by mass in the toner mother particles, and more preferably at least 70.0% by mass and no greater than 90.0% by mass.

The non-crystalline polyester resin has a melting point of preferably at least 100.0° C. and no greater than 150.0° C., and more preferably at least 110.0° C. and no greater than 130.0° C. The non-crystalline polyester resin has a glass transition point of preferably at least 45.0° C. and no greater than 70.0° C., and more preferably at least 55.0° C. and no greater than 65.0° C. The non-crystalline polyester resin has an acid value of preferably at least 3.0 mgKOH/g and no greater than 25.0 mgKOH/g, and more preferably at least 5.0 mgKOH/g and no greater than 15.0 mgKOH/g. The non-crystalline polyester resin has a hydroxyl value of preferably at least 5.0 mgKOH/g and no greater than 50.0 mgKOH/g, and more preferably at least 10.0 mgKOH/g and no greater than 20.0 mgKOH/g. The non-crystalline polyester resin has a mass average molecular weight of preferably at least 90,000 and no greater than 150,000, and more preferably at least 105,000 and no greater than 125,000. The non-crystalline polyester resin has a number average molecular weight of preferably at least 2000 and no greater than 5000, and more preferably at least 3200 and no greater than 4000.

### (Crystalline Polyester Resin)

When the binder resin includes a crystalline polyester resin, the crystalline polyester resin preferably includes a fourth repeating unit derived from a styrene compound. The fourth repeating unit imparts the aforementioned structure derived from styrene to the toner particles. The styrene compound is preferably styrene.

The percentage content of the fourth repeating unit is preferably at least 0.5% by mass and no greater than 8.0% by mass in all repeating units included in the crystalline polyester resin, and more preferably at least 1.5% by mass and no greater than 3.0% by mass. As a result of the percentage content of the fourth repeating unit being set to at least 0.5% by mass and no greater than 8.0% by mass in all the repeating units included in the crystalline polyester resin, the height of the peak appearing at a wavenumber of 701 cm⁻¹ in the infrared absorption spectrum of the toner particles plotted by the infrared spectroscopy can be easily adjusted in a range of at least 0.0070 A and no greater than 0.0300 A.

The crystalline polyester resin preferably includes a fifth repeating unit derived from a diol compound, a sixth repeating unit derived from a dibasic carboxylic acid, and a seventh repeating unit derived from a (meth)acrylic acid alkyl ester. The diol compound is preferably 1,4-butanediol or 1,6-hexanediol. The dibasic carboxylic acid is preferably fumaric acid. The (meth)acrylic acid alkyl ester is preferably n-butyl (meth)acrylate.

The percentage content of the fifth repeating unit is preferably at least 30.0% by mass and no greater than 55.0% by mass in all the repeating units included in the crystalline polyester resin, and more preferably at least 42.0% by mass and no greater than 48.0% by mass.

The percentage content of the sixth repeating unit is preferably at least 40.0% by mass and no greater than 65.0% by mass in all the repeating units included in the crystalline polyester resin, and more preferably at least 50.0% by mass and no greater than 55.0% by mass.

The percentage content of the seventh repeating unit is preferably at least 0.5% by mass and no greater than 5.0% by mass in all the repeating units included in the crystalline polyester resin, and more preferably at least 0.8% by mass and no greater than 2.0% by mass.

The crystalline polyester resin has a percentage content of preferably at least 5.0% by mass and no greater than 40.0% by mass in the toner mother particles, and more preferably at least 8.0% by mass and no greater than 12.0% by mass.

The crystalline polyester resin has a softening point of preferably at least 70.0° C. and no greater than 1000.0° C., and more preferably at least 85.0° C. and no greater than 90.0° C. The crystalline polyester resin has a melting point of preferably at least 70.0° C. and no greater than 90.0° C., and more preferably at least 75.0° C. and no greater than 85.0° C. The crystalline polyester resin has an acid value of preferably at least 2.0 mgKOH/g and no greater than 3.7 mgKOH/g, and more preferably at least 2.8 mgKOH/g and no greater than 3.4 mgKOH/g. The crystalline polyester resin has a hydroxyl value of preferably at least 5.0 mgKOH/g and no greater than 25.0 mgKOH/g, and more preferably at least 10.0 mgKOH/g and no greater than 20.0 mgKOH/g. The crystalline polyester resin has a mass average molecular weight of preferably at least 20,000 and no greater than 60,000, and more preferably at least 25,000 and no greater than 40,000. The crystalline polyester resin has a number average molecular weight of preferably at least 2000 and no greater than 5000, and more preferably at least 3200 and no greater than 4000.

### (Colorant)

The toner mother particles may contain a colorant. The colorant may be a known pigment or dye that matches the color of the toner of the present disclosure. In terms of forming high-quality images with the toner of the present disclosure, the colorant has a content of preferably at least 1.0 part by mass and no greater than 20.0 parts by mass relative to 100 parts by mass of the binder resin, and more preferably at least 2.0 parts by mass and no greater than 5.0 parts by mass.

The toner mother particles may contain a black colorant. The black colorant may be carbon black, for example. Alternatively, the black colorant may be a colorant whose color is adjusted to a black color using a yellow colorant, a magenta colorant, and a cyan colorant.

The toner mother particles may contain a non-black colorant. Examples of the non-black colorant include a yellow colorant, a magenta colorant, and a cyan colorant.

At least one compound selected from the group consisting of a condensed azo compound, an isoindolinone compound, an anthraquinone compound, an azo metal complex, a methine compound, and an arylamide compound can be used as the yellow colorant, for example. Examples of the yellow colorant include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, or 194), Naphthol Yellow S, Hansa Yellow G, and C.I. Vat Yellow.

At least one compound selected from the group consisting of a condensed azo compound, a diketopyrrolopyrrole compound, an anthraquinone compound, a quinacridone compound, a basic dye lake compound, a naphthol compound, a benzimidazolone compound, a thioindigo compound, and a perylene compound can be used as the magenta colorant, for example. Examples of the magenta colorant include C.I. Pigment Red (2, 3, 5, 6, 7, 19, 23, 48:2, 48:3, 48:4, 57:1, 81:1, 122, 144, 146, 150, 166, 169, 177, 184, 185, 202, 206, 220, 221, or 254).

At least one compound selected from the group consisting of a copper phthalocyanine compound, an anthraquinone compound, and a basic dye lake compound can be used as the cyan colorant, for example. Examples of the cyan colorant include C.I. Pigment Blue (1, 7, 15, 15:1, 15:2, 15:3, 15:4, 60, 62, or 66), Phthalocyanine Blue, C.I. Vat Blue, and C.I. Acid Blue.

### (Charge Control Agent)

The toner mother particles may contain a charge control agent. The charge control agent is used for the purpose of providing a toner with excellent charge stability or charge rise characteristics. The charge rise characteristics of a toner serve as an indicator as to whether the toner can be charged to a specific charge level in a short period of time. Cationic nature of the toner mother particles can be enhanced by the toner mother particles containing a positively chargeable charge control agent.

Examples of the positively chargeable charge control agent include azine compounds, direct dyes, acid dyes, alkoxylated amine, alkylamide, quaternary ammonium salt compounds, and resins having a quaternary ammonium cationic group. The charge control agent is preferably a quaternary ammonium salt compound.

Examples of the azine compounds include pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline.

Examples of the direct dyes include Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL.

Examples of the acid dyes include nigrosine BK, nigrosine NB, and nigrosine Z.

Examples of the quaternary ammonium salt compounds include benzyldecylhexylmethyl ammonium chloride, decyltrimethyl ammonium chloride, 2-(methacryloyloxy)ethyl trimethylammonium chloride, and dimethylaminopropyl acrylamide methyl chloride quaternary salt.

In terms of providing a toner with excellent charge stability, the charge control agent has a content of preferably at least 0.1 parts by mass and no greater than 5.0 parts by mass relative to 100 parts by mass of the binder resin, and more preferably at least 0.5 parts by mass and no greater than 3.0 parts by mass.

### (Releasing Agent)

The toner mother particles may contain a releasing agent. The releasing agent is used for the purpose of imparting offset resistance to the toner of the present disclosure, for example. In terms of imparting sufficient offset resistance to the toner of the present disclosure, the releasing agent has a content of preferably at least 1.0 part by mass and no greater than 20.0 parts by mass relative to 100 parts by mass of the binder resin, and more preferably at least 3.0 parts by mass and no greater than 8.0 parts by mass.

Examples of the releasing agent include aliphatic hydrocarbon-based waxes, oxides of aliphatic hydrocarbon-based waxes, plant waxes, animal waxes, mineral waxes, ester waxes having a fatty acid ester as a main component, and waxes in which a fatty acid ester has been partially or fully deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include oxidized polyethylene waxes and block copolymers of oxidized polyethylene waxes. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes having a fatty acid ester as a main component include montanic acid ester wax and castor wax. Examples of the waxes in which a fatty acid ester has been partially or fully deoxidized include deoxidized carnauba wax. The releasing agent is preferably an ester wax.

When the toner mother particles contain a releasing agent, a compatibilizer may be added to the toner mother particles in order to improve compatibility between the binder resin and the releasing agent.

### (External Additive)

Inorganic particles are preferable as the external additive. The inorganic particles are preferably silica particles or particles of a metal oxide (specific examples include alumina, titanium oxide, magnesium oxide, zinc oxide, strontium titanate, and barium titanate), and silica particles or titanium oxide particles are more preferable. The silica particles have a number average primary particle diameter of preferably at least 5 nm and no greater than 200 nm, and more preferably at least 10 nm and no greater than 40 nm. The titanium oxide particles have a number average primary particle diameter of preferably at least 50 nm and no greater than 600 nm, and more preferably at least 300 nm and no greater than 450 nm.

In terms of allowing the external additive to sufficiently exhibiting its function while inhibiting detachment thereof from the toner mother particles in the toner particles, the external additive has a content of preferably at least 0.1 parts by mass and no greater than 15.0 parts by mass relative to 100 parts by mass of the toner mother particles, and more preferably at least 1.0 part by mass and no greater than 4.0 parts by mass.

### [Toner Production Method]

The toner of the present disclosure can be produced by a production method including a toner mother particle preparation process and an external additive addition process, for example.

### (Toner Mother Particle Preparation Process)

In the toner mother particle preparation process, the toner mother particles are prepared by pulverization. The toner mother particle preparation process includes a melt-kneading step and a pulverizing step, for example. The toner mother particle preparation process may further include a mixing step before the melt-kneading step. Alternatively or additionally, the toner mother particle preparation process may further include at least one of a finely pulverizing step and a classifying step after the pulverizing step.

In the mixing step, the binder resin and an internal additive added as necessary are mixed to obtain a mixture. In the melt-kneading step, a toner material is melted and kneaded to obtain a melt-kneaded product. The toner material is the mixture obtained in the mixing step, for example. In the pulverizing step, the resulting melt-kneaded product is cooled to for example room temperature (25° C.), followed by pulverization to obtain a pulverized product. If it is necessary to reduce the diameter of the pulverized product obtained in the pulverizing step, a step (finely pulverizing step) of further pulverizing the pulverized product may be performed. In addition, if the particle diameter of the pulverized product is to be averaged, a step (classifying step) of classifying the resulting pulverized product may be performed. Through the above steps, toner mother particles being the pulverized product are obtained.

### (External Additive Addition Process)

In the external additive addition process, the resulting toner mother particles are mixed with the external additive using a mixer to attach the external additive to the surfaces of the toner mother particles. Thus, the toner of the present disclosure is obtained. The external additive includes the specific external additive particles and the additional external additive particles added as necessary. The mixer may be an FM mixer (product of Nippon Coke & Engineering Co., Ltd.), for example.

### EXAMPLES

The following further provides specific description of the present disclosure using examples. However, the present disclosure is not limited to the scope of the examples.

### [Volume Median Diameter Measurement]

The volume median diameters (D₅₀) of toner mother particles were measured using a particle size meter (“COULTER COUNTER MULTISIZER 3”, product of Beckman Coulter, Inc.).

### [Infrared Spectroscopy]

In infrared spectroscopy, a Fourier transform infrared spectrometer (“FRONTIER”, product of PerkinElmer Japan Co., Ltd.) was used as a measuring device. The measurement was performed in an attenuated total reflection (ATR) mode. Diamond (refractive index 2.4) was used as ATR crystal.

The ATR crystal was loaded in the measuring device, and 1 mg of a measurement target (any of toners of Examples and Comparative Examples described later) was placed on the ATR crystal. Subsequently, a pressure at a load of at least 60 N and no greater than 80 N was applied to the measurement target (sample) using a pressure arm of the measuring device. Subsequently, the FT-IR spectrum (horizontal axis: wavenumber of irradiated infrared rays, vertical axis: absorbance) of the sample was plotted under the condition of an infrared light incident angle of 45 degrees. The height of a peak appearing at a wavenumber of 701 cm⁻¹ (peak indicating the structure derived from styrene) was read from the plotted FT-IR spectrum.

### [Mass Average Molecular Weight Measurement and Number Average Molecular Weight Measurement]

The mass average molecular weight and the number average molecular weight of a measurement target (polyester resin or toner particles) were measured by the following method. First, 10 mg of the measurement target and 5 μmL of tetrahydrofuran (THF) were mixed to yield a mixture. The resulting mixture was left to stand at room temperature for 2 hours. Next, the mixture was further stirred to sufficiently mix the measurement target with the THF. Next, the mixture was filtered through a sample treatment filter (“TITAN 2-30 PTFE 0.45 μm ECOPACK”, product of Tomsic Ltd.). The filtered mixture was used as a gel filtration chromatography (GPC) sample. The mass average molecular weight and the number average molecular weight of a resin contained in the GPC sample were measured by GPC under the following conditions.

### (GPC Conditions)

Measuring device: “HLC-8220GPC” produced by Tosoh Corporation
Columns: ultra-high performance semi-micro SEC columns (“TSKGEL SUPERMULTIPORE HZ-H”, product of Tosoh Corporation, filler: styrene-divinylbenzene resin, column size: inner diameter 4.6 mm×length 15 cm, filler particle diameter: 6 μm)
Number of columns: 3
Eluent: tetrahydrofuran
Eluate flow rate: 1.0 mL/min
Sample solution amount: 150 μL
Column temperature: 40° C.
Detector: RI (refractive index) detector
Calibration curve: calibration curve plotted using n-propylbenzen and monodisperse polystyrene standard samples (F-40, F-20, F-4, F-1, A-5000, A-2500, and A-1000) produced by Tosoh Corporation

### [Non-Crystalline Polyester Resin Synthesis]

Non-crystalline polyester resins A to H were prepared by the following methods. Table 1 below shows the softening point (Tm), the glass transition point (Tg), the acid value, the hydroxyl value, the mass average molecular weight (Mw), and the number average molecular weight (Mn) of each of the non-crystalline polyester resins A to H.

### (Non-Crystalline Polyester Resin A)

A four-necked flask equipped with a thermometer (thermocouple), a dewatering conduit, a nitrogen inlet tube, and a stirrer was used as a reaction vessel. Into the reaction vessel, 1,700 parts by mass of a bisphenol A-propylene oxide adduct (BPA-PO) and 650 parts by mass of a bisphenol A-ethylene oxide adduct (BPA-EO) each as a polyhydric alcohol, 200 parts by mass of dodecenylsuccinic anhydride as a polybasic carboxylic acid, 400 parts by mass of terephthalic acid, 100 parts by mass of trimellitic anhydride, and 4 parts by mass of dibutyltin oxide as a catalyst were added. Subsequently, the contents of the reaction vessel were allowed to react (first reaction) for 9 hours at a temperature of 220° C. under the atmospheric pressure while removing water produced during the reaction. Thereafter, the contents of the reaction vessel were allowed to further react (second reaction) at a temperature of 220° C. under a reduced pressure atmosphere (pressure 8.0 kPa). During the second reaction, the reaction time was adjusted so that the product (non-crystalline polyester resin A) had a softening point indicated below in Table 1. After the second reaction, the contents of the reaction vessel were taken out and cooled. Thus, the non-crystalline polyester resin A (softening point 124.8° C.) was obtained.

### (Non-Crystalline Polyester Resins B to H)

The non-crystalline polyester resins B to H were prepared according to the same method as that for preparing the non-crystalline polyester resin A in all aspects other than the following changes. In the preparation of the non-crystalline polyester resins B to H, the amounts of the materials used were changed to those shown below in Table 1. Also in the preparation of the non-crystalline polyester resins B to H, the reaction time in the second reaction was adjusted so that the resulting products had the respective softening points shown below in Table 1.

In Table 1 below, “DDSA” refers to dodecenyl succinic anhydride. “TPA” refers to terephthalic acid. “TMA” refers to trimellitic anhydride. “Part” refers to parts by mass.

TABLE 1

| | | Non-crystalline polyester resin | | | | | | | |
|---|---|---|---|---|---|---|---|---|---|
| | | A | B | C | D | E | F | G | H |
| Polyhydric | BPA-PO | 1700 | 1500 | 1400 | 1600 | 1400 | 1800 | 1750 | 1650 |
| alcohol [Part] | BPA-EO | 650 | 300 | 500 | 700 | 600 | 550 | 400 | 300 |
| Polybasic carboxylic | DDSA | 200 | 100 | 300 | 50 | 300 | 300 | 400 | 500 |
| acid [Part] | TPA | 400 | 200 | 500 | 550 | 600 | 200 | 250 | 220 |
| | TMA | 100 | 75 | 150 | 80 | 180 | 10 | 300 | 220 |

| | | | | | | | | |
|---|---|---|---|---|---|---|---|---|
| Tm [° C.] | 124.8 | 111.6 | 138.5 | 111.8 | 121.4 | 133.2 | 129.4 | 141.0 |
| Tg [° C.] | 57.2 | 64.2 | 58.0 | 64.2 | 66.1 | 59.2 | 60.1 | 58.2 |
| Acid value [mgKOH/g] | 6.0 | 15.0 | 14.0 | 15.0 | 19.0 | 9.0 | 12.0 | 7.0 |
| Hydroxyl value [mgKOH/g] | 41.0 | 14.0 | 34.5 | 14.0 | 18.0 | 20.0 | 30.0 | 19.0 |
| Mw | 109500 | 99000 | 122000 | 119000 | 124000 | 98000 | 132000 | 128000 |
| Mn | 3800 | 3500 | 2900 | 3300 | 2800 | 3100 | 3800 | 3400 |

### [Crystalline Polyester Resin Synthesis]

Crystalline polyester resins a to e were prepared by the following methods. Table 2 below shows the softening point (Tm), the melting point (Mp), the acid value, the hydroxyl value, the mass average molecular weight (Mw), and the number average molecular weight (Mn) of each of the crystalline polyester resins a to e.

### (Crystalline Polyester Resin a)

A four-necked flask equipped with a thermometer (thermocouple), a dewatering conduit, a nitrogen inlet tube, and a stirrer was used as a reaction vessel. Into the reaction vessel, 995 parts by mass of 1,4-butanediol and 260 parts by mass of 1,6-hexanediol each as a polyhydric alcohol, 1500 parts by mass of fumaric acid as a polybasic carboxylic acid, and 2.5 parts by mass of hydroquinone were added. Subsequently, the contents of the reaction vessel were allowed to react (first reaction) at a temperature of 170° C. under the atmospheric pressure for 5 hours while removing water produced during the reaction. Next, the contents of the reaction vessel were allowed to further react (second reaction) at a temperature of 210° C. under the atmospheric pressure for 1.5 hours. Next, the contents of the reaction vessel were allowed to further react (third reaction) for 1.0 hour at a temperature of 210° C. under a reduced pressure atmosphere (pressure 8.0 kPa). Next, 70 parts by mass of styrene and 50 parts by mass of butyl methacrylate each as a vinyl compound were added into the reaction vessel. Next, the contents of the reaction vessel were allowed to further react (fourth reaction) for 1.5 hours at a temperature of 210° C. under the atmospheric pressure. Next, the contents of the reaction vessel were allowed to further react (fifth reaction) for 1 hour at a temperature of 210° C. under a reduced pressure atmosphere (pressure 8.0 kPa). After the fifth reaction, the contents of the reaction vessel were taken out and cooled. Thus, the crystalline polyester resin a was obtained.

### (Crystalline Polyester Resins b to e)

The crystalline polyester resins b to e were prepared according to the same method as that for preparing the crystalline polyester resin a in all aspects other than the following changes. In the preparation of the crystalline polyester resins b to e, the amounts of the materials used were changed to those shown below in Table 2. Note that “Part” below in Table 2 refers to part by mass.

TABLE 2

| | | Crystalline polyester resin | | | | |
|---|---|---|---|---|---|---|
| | | a | b | c | d | e |
| Polyhydric alcohol [Part] | 1,4-butanediol | 995 | 1060 | 960 | 1060 | 901 |
| | 1,6-hexanediol | 260 | 220 | 187 | 220 | 77 |
| Polybasic carboxylic acid | Fumaric acid | 1500 | 1480 | 1480 | 1480 | 1480 |
| Vinyl compound | Styrene | 70 | 40 | 140 | — | 276 |
| | Butyl methacrylate | 50 | 25 | 108 | — | 216 |

| | | | | | |
|---|---|---|---|---|---|
| Tm [° C.] | 88.8 | 88.4 | 88.7 | 86.5 | 88.8 |
| Mp [° C.] | 82.0 | 78.5 | 78.5 | 82.0 | 70.5 |
| Acid value [mgKOH/g] | 3.1 | 3.5 | 3.0 | 1.0 | 3.9 |
| Hydroxyl value [mgKOH/g] | 19.0 | 11.1 | 7.0 | 30.8 | 14.0 |
| Mw | 27500 | 52800 | 45000 | 17370 | 71000 |
| Mn | 3620 | 3590 | 3590 | 3680 | 3300 |

### <Toner Preparation>

Toners of Examples 1 to 13 and Comparative Examples 1 to 7 were prepared by the following methods.

### Example 1

Using an FM mixer (“FM-20B”, product of Nippon Coke & Engineering Co., Ltd.), 80.0 parts by mass of the non-crystalline polyester resin A and 10.0 parts by mass of the crystalline polyester resin a each as a binder resin, 4.0 parts by mass of carbon black (“MA-100”, product of Mitsubishi Chemical Corporation, number average primary particle diameter 24 nm) as a colorant, ester wax (“NISSAN ELECTOL (registered Japanese trademark) WEP-3”, product of NOF CORPORATION, melting point: 73° C.) as a releasing agent, and 1.0 part by mass of a quaternary ammonium salt compound (“BONTRON (registered Japanese trademark) P-51”, product of ORIENT CHEMICAL INDUSTRIES CO., LTD.) as a charge control agent were mixed at a rotational speed of 200 rpm for 4 minutes.

Thereafter, the resulting mixture was melt-kneaded using a two-axis extruder (“PCM-30”, product of Ikegai Corp.) under conditions of a material input speed of 6 kg/hour, a shaft rotational speed of 160 rpm, and a cylinder temperature of 120° C. Thereafter, the resulting melt-kneaded product was cooled. The cooled melt-kneaded product was coarsely pulverized using a ROTOPLEX (registered Japanese trademark) mill (“Model 8/16”, product of TOA KIKAI SEISAKUSHO) followed by fine pulverization using a mechanical pulverizer (“TURBO MILL”, product of FREUND-TURBO CORPORATION). The resulting finely pulverized product was classified using a classifier (“EJ-LABO, Model EJ-L-3”, product of Nittetsu Mining Co., Ltd.). Through the above, powdery toner mother particles were obtained whose volume median diameter was 5.82 μm.

Using an FM mixer (“FM-10”, product of Nippon Coke & Engineering Co., Ltd.), 100.0 parts by mass of the toner mother particles, 1.2 parts by mass of hydrophobic silica particles (“AEROSIL (registered Japanese trademark) RA-200H”, product of NIPPON AEROSIL CO., LTD., number average primary particle diameter 12 nm) as an external additive, and 0.8 parts by mass of titanium oxide particles (“EC-100”, product of Titan Kogyo, Ltd.) were mixed at a rotational speed of 3000 rpm and a jacket control temperature of 20° C. for 2 minutes. Thus, a black toner of Example 1 was obtained.

A cyan toner of Example 1, a magenta toner of Example 1, and a yellow toner of Example 1 were prepared according to the same method as that for preparing the black toner of Example 1 in all aspects other than that the type of colorant was changed to those shown below. In the following, the black toner, the cyan toner, the magenta toner, and the yellow toner of Example 1 are also referred to below collectively as “toners of Example 1”.
Colorant for magenta toner use: “C.I. Pigment Red 269” produced by SANYO COLOR WORKS, Ltd.
Colorant for cyan toner use: “C.I. Pigment Blue 15:3” produced by SANYO COLOR WORKS, Ltd.
Colorant for yellow toner use: “C.I. Pigment Yellow 74” produced by Dainichiseika Color & Chemicals Mfg. Co., Ltd.

### Examples 2 to 13 and Comparative Examples 1 to 7

Toners of Examples 2 to 13 and Comparative Examples 1 to 7 were prepared according to the same method as that for preparing the toners of Example 1 in all aspects other than that the amounts and types of non-crystalline polyester resin and crystalline polyester resin used in the toner mother particle preparation and the volume median diameter (D₅₀) of the toner mother particles were changed to those shown below in Table 3. In property measurement and performance evaluation of the toners of Examples and Comparative Examples, the black toners were used as representative examples to measure and evaluate those unaffected by any colorants.

TABLE 3

| | Non-crystalline | | Crystalline | | |
|---|---|---|---|---|---|
| | polyester resin | | polyester resin | | D₅₀ |
| | Type | Part | Type | Part | [μm] |
| Example 1 | A | 80.0 | a | 10.0 | 5.82 |
| Example 2 | A | 80.0 | a | 10.0 | 5.50 |
| Example 3 | A | 80.0 | a | 10.0 | 6.20 |
| Example 4 | B | 80.0 | a | 10.0 | 5.81 |
| Example 5 | C | 80.0 | a | 10.0 | 5.80 |
| Example 6 | D | 80.0 | a | 10.0 | 5.92 |
| Example 7 | E | 80.0 | a | 10.0 | 5.76 |
| Example 8 | A | 80.0 | b | 10.0 | 5.68 |
| Example 9 | A | 80.0 | c | 10.0 | 5.81 |
| Example 10 | A | 63.0 | a | 27.0 | 6.02 |
| Example 11 | A | 85.5 | a | 4.5 | 6.12 |
| Comparative Example 1 | A | 80.0 | a | 10.0 | 5.03 |
| Comparative Example 2 | A | 80.0 | a | 10.0 | 6.84 |
| Comparative Example 3 | F | 80.0 | a | 10.0 | 5.72 |
| Comparative Example 4 | G | 80.0 | a | 10.0 | 5.69 |
| Comparative Example 5 | H | 80.0 | a | 10.0 | 5.88 |
| Comparative Example 6 | A | 80.0 | d | 10.0 | 5.71 |
| Comparative Example7 | A | 80.0 | e | 10.0 | 5.66 |
| Example 12 | D | 63.0 | a | 27.0 | 5.92 |
| Example 13 | D | 85.5 | a | 4.5 | 6.01 |

### [Infrared Spectroscopy]

Infrared spectroscopy (FT-IR) was performed on each of the black toners of the toners of Examples 1 to 13 and Comparative Examples 1 to 7 by the aforementioned method to plot an infrared absorption spectrum of the toner particles of the black toner. Thereafter, the height of a peak appearing at a wavenumber of 701 cm⁻¹ was determined in the infrared absorption spectrum. The measurement results are shown below in Table 4.

### [Tetrahydrofuran-Insoluble Component Measurement]

For each of the black toners of the toners of Examples 1 to 13 and Comparative Examples 1 to 7, the percentage content of the tetrahydrofuran-insoluble component in the binder resin was measured by the following method. First, 40 mL of tetrahydrofuran (THF) and 0.05 g of a measurement target were added into a sample bottle. The measurement target used was a mixture of the same compositions as those of the binder resin contained in the toner (e.g., a mixture of 0.044 g of the non-crystalline polyester resin A and 0.006 g of the crystalline polyester resin a in the black toner of Example 1). The contents of the sample bottle were stirred for 3 hours using a rotary mixer and then left to stand for 24 hours. Thereafter, 5 mL of the supernatant was collected from the sample bottle using a syringe. The collected supernatant in an amount of 5 mL was transferred to a metal dish and allowed to air-dry. The component remaining on the metal dish after the air-drying was taken as a tetrahydrofuran-insoluble component of the binder resin yet to be subjected to the ultrasonication.

A mass m of the tetrahydrofuran-insoluble component of the binder resin, which had not yet been subjected to the ultrasonication and which remained on the metal dish, was measured. The value obtained by multiplying the mass m by 8 corresponds to a mass M of a component dissolved in 40 mL of the THF in 0.05 g of the measurement target. By applying the measured mass M to the following equation, a percentage content of the tetrahydrofuran-insoluble component in the binder resin of the measurement target yet to be subjected to the ultrasonication was calculated. The measurement results are shown below in Table 4.

Tetrahydrofuran-insoluble component=100×[0.05 g −(mass M [g])]/0.05 g

Next, the percentage content of the tetrahydrofuran-insoluble component in the binder resin subjected to the ultrasonication was measured for each of the black toners of the toners of Examples 1 to 13 and Comparative Examples 1 to 7. Into a sample bottle, 40 mL of tetrahydrofuran (THF) and 0.05 g of the measurement target (mixture of the same compositions as those of the binder resin contained in the toner) were added. Ultrasonication at an output power of 200 W and a frequency of 28 kHz was performed on the contents of the sample bottle for 1 minute. Next, the contents of the sample bottle were stirred for 3 hours using a rotary mixer and then left to stand for 24 hours. Thereafter, 5 mL of the supernatant was collected from the sample bottle using a syringe. The collected supernatant in an amount of 5 mL was transferred to a metal dish and allowed to air-dry. The component remaining on the metal dish after the air-drying was taken as a tetrahydrofuran-insoluble component of the binder resin subjected to the ultrasonication. Thereafter, a percentage content of the tetrahydrofuran-insoluble component in the binder resin subjected to the ultrasonication was calculated according to the same method as that for measuring the percentage content of the tetrahydrofuran-insoluble component in the binder resin yet be subjected to the ultrasonication. The measurement results are shown below in Table 4.

### [Mass Average Molecular Weight of Resin Contained in Toner Particles]

The mass average molecular weight of the resin contained in the toner particles of each of the black toners of the toners of Examples 1 to 13 and Comparative Examples 1 to 7 was measured by the aforementioned method. The measurement results are shown below in Table 4.

TABLE 4

| | THF-insoluble component | | | |
|---|---|---|---|---|
| | [% by mass] | | | |
| | Before | After | | Toner |
| | ultra- | ultra- | FT-IR | parti- |
| | soni- | soni- | peak | cles |
| | cation | cation | [A] | Mw |
| Example 1 | 8.41 | 1.11 | 0.0175 | 105000 |
| Example 2 | 8.41 | 1.11 | 0.0175 | 105000 |
| Example 3 | 8.41 | 1.11 | 0.0175 | 105000 |
| Example 4 | 4.99 | 0.33 | 0.0156 | 92000 |
| Example 5 | 15.20 | 1.98 | 0.0169 | 118000 |
| Example 6 | 7.49 | 0.22 | 0.0166 | 111000 |
| Example 7 | 14.21 | 2.05 | 0.0177 | 118000 |
| Example 8 | 8.41 | 1.11 | 0.0099 | 114000 |
| Example 9 | 8.41 | 1.11 | 0.0252 | 92100 |
| Example 10 | 8.41 | 1.11 | 0.0244 | 89900 |
| Example 11 | 8.41 | 1.11 | 0.0122 | 120000 |
| Comparative Example 1 | 8.41 | 1.11 | 0.0175 | 105000 |
| Comparative Example 2 | 8.41 | 1.11 | 0.0175 | 105000 |
| Comparative Example 3 | 3.90 | 0.55 | 0.0181 | 93000 |
| Comparative Example 4 | 16.50 | 2.43 | 0.0183 | 119000 |
| Comparative Example 5 | 14.80 | 2.30 | 0.0172 | 118000 |
| Comparative Example 6 | 8.41 | 1.11 | 0.0025 | 117000 |
| Comparative Example 7 | 8.41 | 1.11 | 0.0334 | 94000 |
| Example 12 | 7.49 | 0.22 | 0.0247 | 79000 |
| Example 13 | 7.49 | 0.22 | 0.0135 | 135000 |

### <Evaluations>

Coloring of formed images, low-temperature fixability, and heat-resistant preservability were evaluated by the following methods for the toners of Examples 1 to 13 and Comparative Examples 1 to 7. The evaluations were performed under conditions of a temperature of 23° C. and a relative humidity of 50% unless otherwise stated. The evaluation results are shown below in Table 5.

### [Developer Preparation]

Using a powder mixer (ROCKING MIXER (registered Japanese trademark), product of AICHI ELECTRIC CO., LTD., mixing method: container rocking/rotating method), 8 parts by mass of a toner (any of the toners of Examples 1 to 13 and Comparative Examples 1 to 7) being an evaluation target and 100 parts by mass of a carrier (carrier for “TASKALFA 7054CF” produced by KYOCERA Document Solutions Japan Inc.) were mixed for 30 minutes. This resulted in obtaining an initial evaluation developer (specifically, any of an initial evaluation developer for black toner use, an initial evaluation developer for magenta toner use, an initial evaluation developer for cyan toner use, and an initial evaluation developer for yellow toner use, toner concentration approximately 7% by mass) being an evaluation target.

Using the aforementioned powder mixer, 100 parts by mass of a toner (any of the toners of Examples 1 to 13 and Comparative Examples 1 to 7) and 10 parts by mass of a carrier (carrier for “TASKalfa 7054ci” produced by KYOCERA Document Solutions Japan Inc.) were mixed for 30 minutes. This resulted in obtaining an evaluation developer for replenishment containing the toner being an evaluation target (specifically, any of an evaluation developer for black toner replenishment, an evaluation developer for magenta toner replenishment, an evaluation developer for cyan toner replenishment, and an evaluation developer for yellow toner replenishment, toner concentration approximately 91% by mass).

### [Evaluation Apparatus]

As an evaluation apparatus, a color multifunction peripheral (“TASKalfa 7054ci”, product of KYOCERA Document Solutions Japan Inc., photosensitive drum: amorphous silicon drum) was used. The evaluation apparatus included photosensitive members, development devices that develop electrostatic latent images formed on the photosensitive members with developers (specifically, toner contained in the developers), developer discharge sections that discharge the developers loaded in the development devices, replenishment developer supply sections that supply developers for replenishment use into the development devices, and a fixing device that fixes the toners to a recording medium. That is, the evaluation apparatus adopts the trickle development method. An initial evaluation developer (specifically, any of the initial evaluation developer for black toner use, the evaluation initial developer for magenta toner use, the evaluation initial developer for cyan toner use, and the evaluation initial developer for yellow toner use) was loaded into one of the development devices (specifically, a corresponding one of the development device for black color, the development device for magenta color, the development device for cyan color, and the development device for yellow color) of the evaluation apparatus. A developer for replenishment (specifically a corresponding one of the evaluation developer for black toner replenishment, the evaluation developer for magenta toner replenishment, the evaluation developer for cyan toner replenishment, and the evaluation developer for yellow toner replenishment) was loaded into the developer supply section for black toner replenishment of the evaluation apparatus. The evaluation apparatus was set to have a linear velocity of 322 mm/sec and a toner application amount of 0.37 mg/cm³. The evaluation apparatus was modified so that the fixing temperature of the fixing device was capable of being set arbitrarily. As a recording medium, A4-size plain paper (“C²”, product of FUJIFILM Business Innovation Corp.) was used.

### [Coloring]

Using the evaluation apparatus, solid images (specifically, a black solid image, a cyan solid image, a magenta solid image, and a yellow solid image) were formed on a sheet of the recording medium. The fixing temperature of the fixing device was set to 170° C. The lightness (L*) of the black solid image and the chroma (C*) of each of the cyan solid image, the magenta solid image, and the yellow solid image were measured using a fluorescence spectrodensitometer (“FD-5”, product of KONICA MINOLTA, INC.). A L* of the black solid image of less than 18.0 can be considered as passing, while that of at least 18.0 can be considered as failing. A C* of the cyan solid image of at least 60.0 can be considered as passing, while that of less than 60.0 can be considered as failing. A C* of the magenta solid image of at least 72.0 can be considered as passing, while that of less than 72.0 can be considered as failing. A C* of the yellow solid image of at least 97.0 can be considered as passing, while that of less than 97.0 can be considered as failing. Coloring was evaluated according to the following criteria. Note that “C/M/Y/K” under Coloring below in Table 5 means the chromas (C*) of the cyan solid image, the magenta solid image, and the yellow solid image and the lightness (L*) of the black solid image. For example, “62.2/74.1/99.3/16.2” for “C/M/Y/K” of Example 1 means that the C* of the cyan solid image is 62.2, the C* of the magenta solid image is 74.1, the C* of the yellow solid image is 99.3, and the L* of the black solid image is 16.2.

### (Criteria of Coloring)

A (good): All of L* of black solid image, C* of cyan solid image, C* of magenta solid image, and C* of yellow solid image were passing.
B (poor): At least one of L* of black solid image, C* of cyan solid image, C* of magenta solid image, and C* of yellow solid image was failing.

### [Low-Temperature Fixability]

Using the evaluation apparatus, a black solid image (specifically, an unfixed toner image before passing through the fixing device) with a size of 25 mm×25 mm was formed on a sheet of the recording medium. Subsequently, the sheet of the recording medium (evaluation sheet) with the black solid image formed thereon was allowed to pass through the fixing device. In doing so, a minimum temperature (minimum fixing temperature) at which the black solid image (toner image) was able to be fixed to the evaluation sheet was measured in a manner that the fixing temperature of the fixing device was increased in increments of 5° C. from 120° C. to 220° C. to determine fixing success for each fixing temperature.

Whether or not the toner has been fixed was evaluated by the following fold-rubbing test. In the fold-rubbing test, the evaluation sheet was folded so that the side with the black solid image formed thereon was the inside and so that the fold passed through the center of the black solid image. Next, the fold of the folded evaluation sheet was rubbed back and forth 5 times under a load of 1 kg using a brass weight (1 kg) covered with cotton cloth. Next, the evaluation sheet was unfolded and the length of toner peeling (peeling length) was measured at a part of the fold of the evaluation sheet where the black solid image has been fixed. If the peeling length was no greater than 1 mm, it was determined that the toner passed the fold-rubbing test, indicating successful fixation to the evaluation sheet. If the peeling length is greater than 1 mm, it was determined that the toner failed the fold-rubbing test, indicating unsuccessful fixation to the evaluation sheet. For each of the evaluation developers, the black solid image formation and the fold-rubbing test were repeated while changing the fixing temperature to determine the minimum temperature (minimum fixing temperature) among the fixing temperatures for toners passing the fold-rugging test. Low-temperature fixability was evaluated according to the following criteria.

### (Criteria of Low-Temperature Fixability)

A (very good): minimum fixing temperature of no greater than 150° C.
B(good): minimum fixing temperature of at least 155° C. and no greater than 160° C.
C (poor): minimum fixing temperature of at least 165° C.

### [Heat-Resistant Preservability]

A polyethylene container with a capacity of 20 mL was charged with 3 g of a toner (specifically, any of the black toners of the toners of Examples 1 to 13 and Comparative Examples 1 to 7) being an evaluation target. The container was left to stand in a constant temperature bath set at 55° C. for 3 hours. After the 3-hour leaving, the container was taken out of the constant temperature bath. The toner was taken out of the container and used as an evaluation toner. The resulting evaluation toner was placed on a 200-mesh sieve (opening 75 μm) with a known mass. The mass of the sieve including the evaluation toner was measured then to obtain the mass of the toner before sifting. Subsequently, the sieve was set on a powder characteristics tester (“POWDER TESTER (registered Japanese trademark) PT-X”, product of Hosokawa Micron Corporation) and vibrated at an amplitude of 1.0 mm for 30 seconds in accordance with the manual of the powder characteristics tester to sift the evaluation toner. After the sifting, the mass of toner not having passed through the sieve was measured. Thereafter, an agglomeration rate [% by mass] of the toner was calculated using the following equation based on the mass of the toner before the sifting and the mass of the toner after the sifting. Note that the “mass of toner after the sifting” in the following equation refers to the mass of toner not having passed through the sieve (i.e., toner remaining on the sieve after the sifting). Heat-resistant preservability was evaluated according to the following criteria.

Agglomeration rate [1% by mass]=100×mass of toner after sifting/mass of toner before sifting

### (Criteria of Heat-Resistant Preservability)

A (Very good): agglomeration rate of no greater than 10% by mass
B(good): agglomeration rate of greater than 10% by mass and no greater than 20% by mass
C (poor): agglomeration rate of greater than 20% by mass

TABLE 5

| | Coloring | | Low-temperature fixability | | Heat-resistant preservability | |
|---|---|---|---|---|---|---|
| | C/M/Y/K | Rating | Temperature [° C.] | Rating | Agglomeration rate [%] | Rating |
| Example 1 | 62.2/74.1/99.3/16.2 | A | 145 | A | 5 | A |
| Example 2 | 62.6/74.4/99.9/15.5 | A | 145 | A | 6 | A |
| Example 3 | 61.4/73.3/98.9/17.3 | A | 145 | A | 4 | A |
| Example 4 | 62.5/74.2/99.5/16.0 | A | 140 | A | 7 | A |
| Example 5 | 61.3/72.9/98.1/17.6 | A | 150 | A | 5 | A |
| Example 6 | 62.8/74.6/100.1/15.2 | A | 140 | A | 8 | A |
| Example 7 | 61.1/72.7/97.7/17.7 | A | 150 | A | 6 | A |
| Example 8 | 62.4/73.9/99.1/16.4 | A | 140 | A | 3 | A |
| Example 9 | 62.8/72.9/98.6/16.8 | A | 145 | A | 5 | A |
| Example 10 | 63.5/75.2/100.6/15.2 | A | 145 | A | 4 | A |
| Example 11 | 60.5/72.2/97.3/17.8 | A | 150 | A | 4 | A |
| Comparative Example 1 | 59.5/71.2/96.5/19.2 | B | 145 | A | 14 | B |
| Comparative Example 2 | 58.2/70.3/95.3/19.8 | B | 140 | A | 4 | A |
| Comparative Example 3 | 64.2/74.5/100.2/15.9 | A | 140 | A | 28 | C |
| Comparative Example 4 | 57.5/70.6/95.8/19.1 | B | 160 | B | 2 | A |
| Comparative Example 5 | 57.8/70.9/96.2/19.6 | B | 140 | A | 6 | A |
| Comparative Example 6 | 59.7/72.3/96.8/18.3 | B | 145 | A | 8 | A |
| Comparative Example 7 | 63.5/75.3/99.2/16.2 | A | 140 | A | 45 | C |
| Example 12 | 63.3/75.1/99.8/16.5 | A | 145 | A | 13 | B |
| Example 13 | 60.7/72.5/97.1/17.7 | A | 155 | B | 8 | A |

The toners of Examples 1 to 13 each included toner particles. The toner particles each included a toner mother particle and an external additive attached to the surface of the toner mother particle. The toner mother particles were pulverized toner mother particles. The toner mother particles had a volume median diameter of at least 5.20 μm and no greater than 6.50 μm. The toner mother particles contained a binder resin. The binder resin contained a tetrahydrofuran-insoluble component in a percentage content of at least 4.50% by mass and no greater than 16.00% by mass. The tetrahydrofuran-insoluble component had a percentage content of no greater than 2.20% by mass in the binder resin as subjected to the ultrasonication at an output power of 200 W and a frequency of 28 kHz for 1 minute. In an infrared absorption spectrum of the toner particles plotted by the infrared spectroscopy, a peak appearing at a wavenumber of 701 cm⁻¹ had a height of at least 0.0070 A and no greater than 0.0300 A. The toners of Examples 1 to 13 had excellent low-temperature fixability and heat-resistant preservability and formed images with excellent coloring. In addition, the toners of Examples 1 to 11 contained a resin in the toner particles with a mass average molecular weight of at least 85,000 and no greater than 130,000. As a result, the toners of Examples 1 to 11 had quite excellent low-temperature fixability and heat-resistant preservability.

The toners of Comparative Example 1 by contrast each included toner mother particles with a volume median diameter that was excessively small. The toners of Comparative Example 2 each included toner mother particles with a volume median diameter that was excessively large. It is difficult to impart coloring to images by appropriately covering the surface of a recording medium when the toner mother particles are excessively large or excessively small. As a result, the toners of Comparative Examples 1 and 2 were rated as poor in coloring of the formed images.

The black toner of Comparative Example 3 had a percentage content of the tetrahydrofuran-insoluble component in the binder resin of less than 4.50% by mass. The tetrahydrofuran-insoluble component being a component that imparts elasticity to the binder resin was short in the black toner of Comparative Example 3. As a result, the black toner of Comparative Example 3 was rated as poor in heat-resistant preservability.

The toners of Comparative Example 4 had a percentage content of the tetrahydrofuran-insoluble component in the binder resin of greater than 16.00% by mass. The toners of Comparative Example 4 excessively contained the tetrahydrofuran-insoluble component being a component that inhibits the toner particles from melting and spreading in fixing. As a result, the black toner of Comparative Example 4 was rated as poor in coloring of the formed images.

The toners of Comparative Example 5 had a percentage content of the tetrahydrofuran-insoluble component in the binder resin as subjected to the ultrasonication of greater than 2.20% by mass. The component that will not dissolve in tetrahydrofuran even after the ultrasonication is considered to strongly inhibit the toner particles from melting and spreading in fixing. The black toner of Comparative Example 5, which contained an excessive amount of such a component, was rated as poor in coloring.

The toners of Comparative Example 6 had a peak appearing at a wavenumber of 701 cm⁻¹ with a height of less than 0.0070 A in the infrared absorption spectrum of the toner particles thereof. The height of the peak indicates the amount of the structure derived from styrene contained in the toner particles. The structure derived from styrene imparts chargeability to toners. The toners of Comparative Example 6, in which the amount of the structure derived from styrene was short, had an insufficient amount of charge, resulting in poor coloring of the formed images.

The height of a peak appearing at a wavenumber of 701 cm⁻¹ was less than 0.0070 A in the infrared absorption spectrum of the toner particles of the black toner of Comparative Example 7. The structure derived from styrene in a moderate amount is effective in imparting chargeability to toner particles, but in excess, it reduces heat-resistant preservability of toners. As a result, the black toner of Comparative Example 7 was rated as poor in heat-resistant preservability.

What is claimed is:

1. A toner comprising
toner particles, wherein
the toner particles each include a toner mother particle and an external additive attached to a surface of the toner mother particle,
the toner mother particles are pulverized toner mother particles,
the toner mother particles have a volume median diameter of at least 5.20 μm and no greater than 6.50 μm,
the toner mother particles contain a binder resin,
the binder resin contains a tetrahydrofuran-insoluble component in a percentage content of at least 4.50% by mass and no greater than 16.00% by mass,
the tetrahydrofuran-insoluble component has a percentage content of no greater than 2.20% by mass in the binder resin as subjected to ultrasonication at an output power of 200 W and a frequency of 28 kHz for 1 minute, and
in an infrared absorption spectrum of the toner particles plotted by infrared spectroscopy, a peak appearing at a wavenumber of 701 cm⁻¹ has a height of at least 0.0070 A and no greater than 0.0300 A.

2. The toner according to claim 1, wherein
the toner particles contain a resin with a mass average molecular weight of at least 85,000 and no greater than 130,000.

3. The toner according to claim 1, wherein
the binder resin includes a non-crystalline polyester resin,
the non-crystalline polyester resin includes a first repeating unit derived from tri- or higher-basic carboxylic acid, and
the first repeating unit has a percentage content of at least 1.5% by mass and no greater than 7.5% by mass in all repeating units included in the non-crystalline polyester resin.

4. The toner according to claim 3, wherein
the non-crystalline polyester resin further includes a second repeating unit derived from a bisphenol compound and a third repeating unit derived from a dibasic carboxylic acid.

5. The toner according to claim 1, wherein
the binder resin includes a crystalline polyester resin,
the crystalline polyester resin includes a fourth repeating unit derived from a styrene compound, and
the fourth repeating unit has a percentage content of at least 0.5% by mass and no greater than 8.0% by mass in all repeating units included in the crystalline polyester resin.

6. The toner according to claim 5, wherein
the crystalline polyester resin includes a fifth repeating unit derived from a diol compound, a sixth repeating unit derived from a dibasic carboxylic acid, and a seventh repeating unit derived from (meth)acrylic acid alkyl ester.

7. The toner according to claim 5, wherein
the crystalline polyester resin has a mass average molecular weight of at least 20,000 and no greater than 600,000.

8. The toner according to claim 5, wherein
the crystalline polyester resin has an acid value of at least 2.0 mgKOH/g and no greater than 3.7 mgKOH/g.
